(19) United States
(12) Patent Application Publication
(10) Pub. No.: US 2022/0121423 A1
(43) Pub. Date: Apr. 21, 2022

(54) METHOD AND DEVICE FOR GENERATING A PSEUDO-RANDOM NUMBER SEQUENCE

(71) Applicant: Robert Bosch GmbH, Stuttgart (DE)

(72) Inventor: Alexander Poddey, Wiernsheim (DE)

(21) Appl. No.: 17/449,161

(22) Filed: Sep. 28, 2021

(30) Foreign Application Priority Data
Oct. 20, 2020 (DE) 102020213245.3

(51) Int. Cl. G06F 7/58; G06F 7/485; G06F 9/30

(52) U.S. Cl. CPC G06F 7/582; G06F 9/3001; G06F 7/485

(57) ABSTRACT

A method for generating a pseudo-random number sequence. In the method: in a data structure managed on the state channel, each of the participants commits to at least a number of at first hidden values that corresponds to the number of participants, each of the participants in the data structure respectively repeatedly discloses the values last committed to by that participant, in the stated number, and commits to the same number of further at first hidden values, a member of the sequence is determined by a relation that includes, for each of the participants, at least one of the values disclosed by this participant.

### CROSS REFERENCE

The present application claims the benefit under 35 U.S.C. § 119 of German Patent Application No. DE 102020213245.3 filed on Oct. 20, 2020, which is expressly incorporated herein by reference in its entirety.

### FIELD

The present invention relates to a method for generating a pseudo-random number sequence. The present invention additionally relates to a corresponding device, a corresponding computer program, and a corresponding storage medium.

### BACKGROUND INFORMATION

The terms “decentralized transaction system,” “transaction database,” or “distributed ledger” designate any protocol in computer networks that brings about a consensus regarding the sequence of particular transactions. A frequently seen realization of such a system is based on a blockchain, and forms the foundation of numerous so-called cryptocurrencies.

The consensus method most frequently used in the related art provides a proof of work (PoW) for the production of new valid blocks. In order to counteract excessive energy consumption in the production of such proofs, and to counteract unnecessary growth of the blockchain, so-called transaction or state channels are proposed and generalized, which connect individual participants off the blockchain (off chain), despite being anchored therein. An overview of this technology can be found in COLEMAN, Jeff; HORNE, Liam; XUANJI, Li. “Counterfactual: Generalized state channels” (2018).

German Patent Application No. DE 102018210224 A1 describes, in the specific embodiment of Claim 6, the following method for agreeing on a cooperation between two systems: the first system sends its assumptions regarding the second system, and its guarantees made thereto; conversely, the second system sends its assumptions regarding the first system and guarantees made. A transaction database receives these mutual assumptions and guarantees, checks whether they correspond to one another, establishes, if warranted, a digital safety contract to be concluded between the systems, and finally documents this by adding a corresponding block to a blockchain. It then sends the block, with the safety contract, to both systems, which incorporate the cooperation as soon as they receive the block.

For this purpose, these systems establish a mutual transaction channel on which they exchange information and signed messages, after reception of the block. If one of the systems receives an item of information that infringes the safety contract, it requests arbitration from the transaction database. The transaction database notifies the other system of this, requests the information (that allegedly infringes the safety contract) therefrom, and checks this information based on the contract.

Such smart contracts embody the legal logic of any distributed application (dApp) of a transaction database. German Patent Application No. DE 102018210224 A1 for example describes a smart contract for preparing and/or carrying out transactions between a holder of an end device and a service provider, the smart contract containing conditions of the service provider for services of an information service provider, in particular conditions relating to usage fees, preferably a roadway usage fee, and/or for services of a service provider, in particular conditions relating to surrender fees, preferably parking fees, fueling fees, fees of a charging station for the end device, and/or conditions of guarantee and/or conditions relating to usage fees, preferably fees for a common use of the end device for provision and/or termination of a service, and/or conditions defined by the holder for this end device for assumption and/or termination of the service, the smart contract being carried out in an authorization node of a computer network based on a blockchain.

The generation of random or pseudo-random number sequences (pseudo-random number generation, PRNG), which is used by dApps and by centralized applications, presents a challenge in this setting. This is true in particular for the generation of cryptographically secure random numbers (cryptographically secure pseudo-random number generation, CSPRNG).

### SUMMARY

The present invention provides a method for generating a pseudo-random number sequence, a corresponding device, a corresponding computer program, and a corresponding storage medium.

The approach according to an example embodiment of the present invention is based on the recognition that conventional approaches to cryptographically secure random number generation, e.g., in the context of multi-party computation (MPC) require on the one hand a specifically matched communication between the participants of the MPC committee. On the other hand, trust-free channel constructs, for example anchored in blockchains, are a completely different type of approach to secure interaction, and require a separate form of communication, with the expenses connected therewith.

Thus, for example, trust-free channels are on the one hand constructed in such a way that they are completely secure; therefore, approaches to the generation of random numbers that are not completely secure are unsuitable from the outset. On the other hand, the high additional outlay in channel-protocol-related communication, in turn-based protocols, for example in the form of additional run-throughs for all participants, is disadvantageous, because as a result the risk increases that individual participants can no longer be reached, and thus the dApp cannot be properly continued.

Against this background, an advantage of the method according to an example embodiment of the present invention is that it achieves complete security in the generation of random numbers that can be used in the dApp without additional protocol-related communication, for example additional turns. For this purpose, it makes use of the fact that complete information-theoretic security, such as is standardly present in trust-free channels, can be achieved as long as even only one of the participants does not participate in an attack. However, because no participant of a state channel would take part in an attack on itself, this condition is easily met here, differing from other multi-party calculations.

Here, a so-called determination or commitment method is used that makes it possible for a participant to commit to a value relative to the other participants without itself disclosing this value. Later, the thus at first “hidden” value can then be disclosed to the other participants, i.e., as it were, “revealed.” A method of this type is described in BRASSARD, Gilles; CHAUM, David; CRÉPEAU, Claude, “Minimum disclosure proofs of knowledge,” Journal of computer and system sciences, 1988, vol. 37, no. 2, pp. 156-189. If there are suitably revealed numbers from each participant, then from this a number can be generated, according to a previously agreed-upon method (e.g., summation and mapping in a value range such as [0,1[), in a manner standard in the MPC field, which number can be regarded as random for all participants, because none of the participants can predict this number.

Through the measures disclosed herein, advantageous developments and improvements of the embodiments of the present invention are possible. Thus, it can be provided to manage, on the state channel, a plurality of identical data structures corresponding to the number of participants, the participants disclosing the values in each data structure in a different sequence. This expansion of the protocol to N instances permits the application of the approach according to the present invention even in non-turn-based channel systems such as PERUN, which do not specify a strict sequence of the moves. Here as well, nonetheless, typically a respective turn is carried out by each participant making a move. The protocol, expanded as described, therefore makes it possible for the participants to produce a pseudo-random number in any sequence per turn, while automatically continuing the system in such a way that it is also open to all participants in the next turn.

The basic design outlined above, and its expanded sequence, can in addition be correspondingly multiplied if M random numbers are to be generated at once.

### BRIEF DESCRIPTION OF THE DRAWINGS

Exemplary embodiments of the present invention are shown in the figures and are explained in more detail below.

FIG. 1 shows a flow diagram of a method according to a first specific example embodiment of the present invention.

FIG. 2 shows a data structure managed on a state channel, in a first state.

FIG. 3 shows the data structure in a second state.

FIG. 4 shows the data structure in a third state.

FIG. 5 shows the data structure in a fourth state.

FIG. 6 schematically shows a control device according to a second specific example embodiment of the present invention.

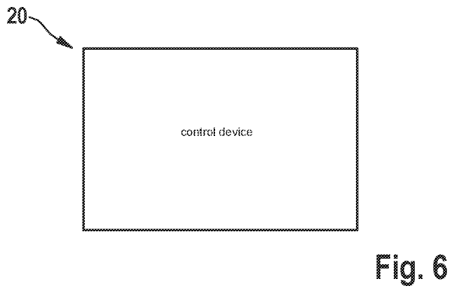

### DETAILED DESCRIPTION OF EXAMPLE EMBODIMENTS

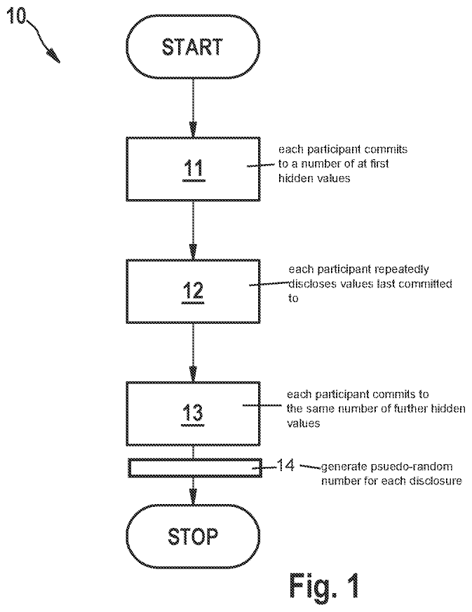

FIG. 1 illustrates the basic sequence of a method (10) according to the present invention. In the data structure managed on the state channel, each of the participants commits to at least a number of at first hidden values (process 11) that corresponds to the number of participants. Each of the participants in the data structure then respectively repeatedly discloses the values last committed to by that participant, in the stated number (process 12), and commits to the same number of further—at first also hidden—values (process 13), so that with each disclosure (12) a pseudo-random number can be generated (process 14).

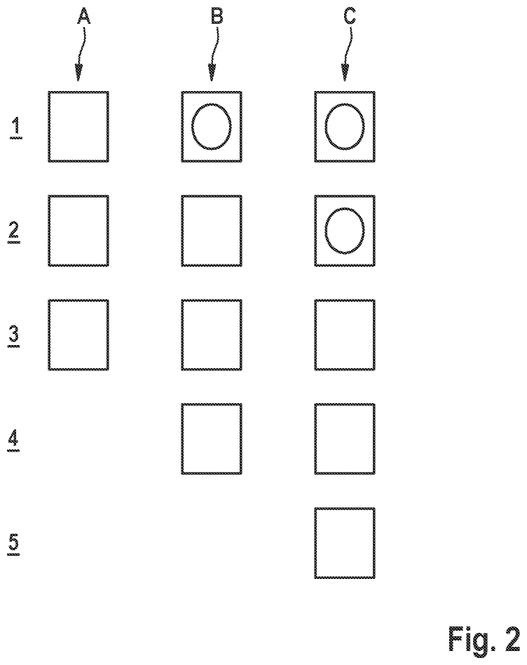

This process is now explained on the basis of the data memory, shown in FIGS. 2 through 5 in successive states in table form, of an exemplary dApp having three participants. For each of the three participants A, B, and C, the values committed to and disclosed by this participant are entered in a column of the respective table, a rectangle representing a value committed to and a circle representing a disclosed value.

In the context of an initialization that may take place when the channel is applied or later, each participant commits to three values. Participant B then reveals the value first committed to by him, and commits to a fourth value; participant C reveals the two values first committed to by him and commits to a fifth value. FIG. 2 shows the data structure after this initialization phase.

Even if two participants, for example B and C, collude against the third participant, they cannot determine the random value formed from the three subvalues of a row, e.g., row 1, as long as a suitable schema is used for the aggregation. For this purpose, in the area of MPC and homomorphic encryption there are different approaches. For example, the random value can be determined by an arithmetical operation such as addition of the three subvalues of the respective row, or some other three-place relation, whose codomain can optionally be limited to a specified interval such as [0,1[.

Because in the specific example, for example participant A committed to a value in row 1 before the two other values in the same row were known, A has no possible way of determining the final random number; i.e., in committing to his (hidden) number he cannot know how the result of the aggregation will come out, as is standard for example in homomorphic encryption.

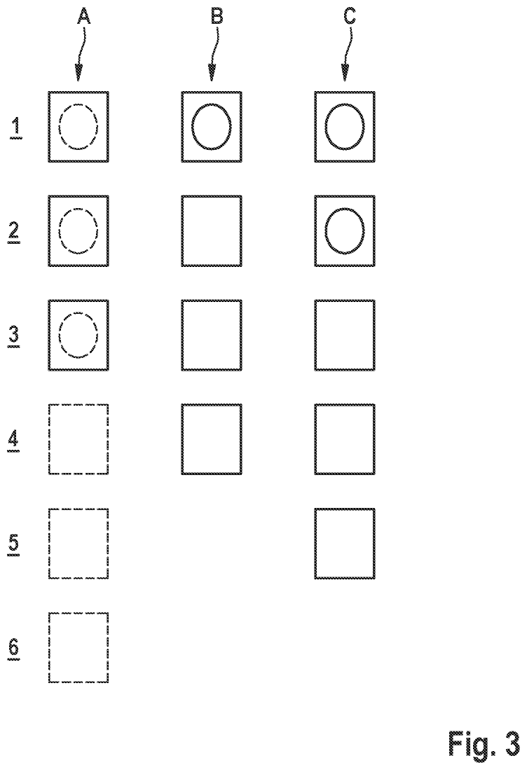

In the present turn-based scenario, participant A, whose turn it is, as shown in FIG. 3, reveals the three still-hidden values.

This gives A the possibility of calculating the secure random number that is to be used in the dApp, because in row 1 all the values are now disclosed. In addition, A commits to three further values, shown in rows 4 through 6.

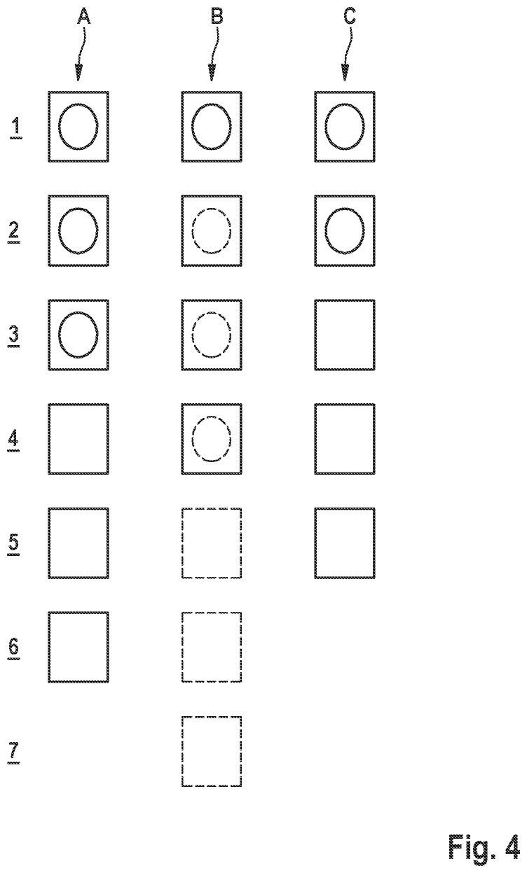

The move of participant A puts participant B in a situation similar to the one participant A was previously in, and participant B now proceeds in a corresponding manner: he discloses the three values that he committed to and that are still hidden, and commits to three further values. In this way, he also obtains a complete row—and thus a secure random number for the dApp—and provides a corresponding situation for participant C, for C's turn (FIG. 4).

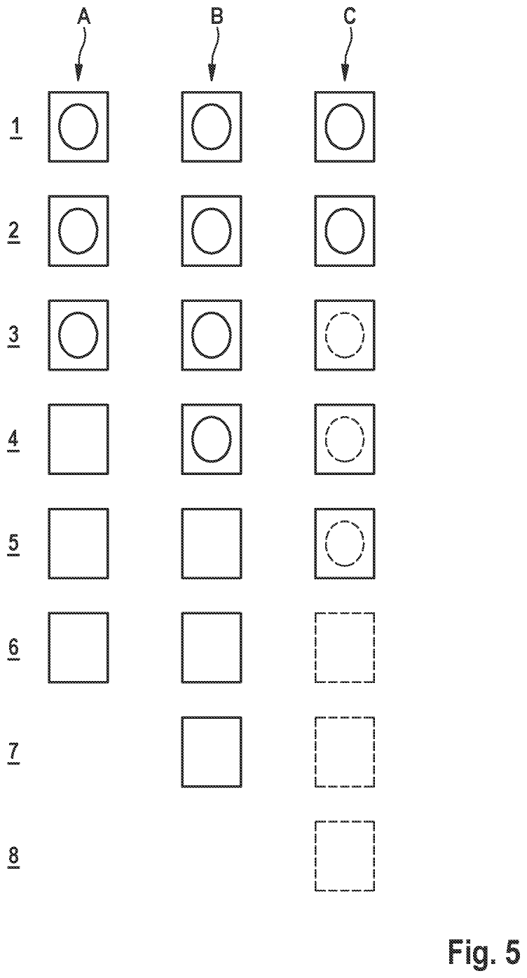

Participant C now carries out the same steps (disclosure of three values and committing to three further values), whereby C also obtains a secure random number for the dApp (FIG. 5). The resulting constellation in turn forms the initial state for the next move by participant A, and so on.

Given a total number of N participants, a value committed to by any participant can be rejected at the latest after N protocol steps or moves, because at this time every other participant has already made their own move, and, through this execution and signature of the move, has accepted the preceding moves. Thus, a structure designed for N²+½N(N−1)+N² values is sufficient, and can be used for example in rolling fashion.

Through this approach, in addition to the standard communication of the dApp memory, which now also contains the described data structure, no additional transmission is required, the values nonetheless being completely secure.

In other cases of application, a random number is not required in each move, so that it is sufficient to reveal values only on request.

If the sequence of participants is not regulated as in the above example, but rather is arbitrary, then an expansion of the approach to N instances proves appropriate, the participants disclosing the values in each instance of the data structure in a different sequence. Thus, given a memory requirement of (N²+½N(N−1)+N²)·N, each participant can generate a random number on demand. The remaining values can be voluntarily revealed at a later time, or their disclosure can be compelled within the next N−1 protocol steps. The formed random numbers can also be supplied to a waiting queue, to be used as needed. This method can be implemented for example in software or hardware, or in a mixed form of software and hardware, for example in a control device (20), as is shown in the schematic representation of FIG. 2.

What is claimed is:

1. A method for generation of a pseudo-random number sequence by a plurality of participants of a state channel, the method comprising the following steps:
committing by each of the participants, in a data structure managed on the state channel, to at least a number of at first hidden values that corresponds to a number of participants;
respectively repeatedly disclosing, by each participant of the participants in the data structure, the number of values last committed to by the participant, and committing to the same number of further at first hidden values;
determining a member of the sequence by a relation that includes, for each of the participants, at least one of the values disclosed by the participant.

2. The method as recited in claim 1, wherein the relation includes an arithmetic operation.

3. The method as recited in claim 2, wherein the operation is an addition.

4. The method as recited in claim 1, wherein the relation has a codomain within a specified interval.

5. The method as recited in claim 4, wherein the relation is real-valued and the interval is [0,1[.

6. The method as recited in claim 1, wherein:
on the state channel, a plurality, corresponding to the number of participants, of data structures of the same type are managed, which include the data structure, and
the disclosure of the values by the participants in the data structures takes place in a sequence that differs between the data structures.

7. The method as recited in claim 6, wherein:
the sequence of the participants is regulated for each of the data structures, or
the sequence of the participants is arbitrary.

8. A non-transitory machine-readable storage medium on which is stored a computer program for generation of a pseudo-random number sequence by a plurality of participants of a state channel, the computer program, when executed by a computer, causing the computer to perform the following steps:
committing by each of the participants, in a data structure managed on the state channel, to at least a number of at first hidden values that corresponds to a number of participants;
respectively repeatedly disclosing, by each participant of the participants in the data structure, the number of values last committed to by the participant, and committing to the same number of further at first hidden values;
determining a member of the sequence by a relation that includes, for each of the participants, at least one of the values disclosed by the participant.

9. A device configured to generate a pseudo-random number sequence by a plurality of participants of a state channel, the device configured to:
commit by each of the participants, in a data structure managed on the state channel, to at least a number of at first hidden values that corresponds to a number of participants;
respectively repeatedly disclose, by each participant of the participants in the data structure, the number of values last committed to by the participant, and commit to the same number of further at first hidden values;
determine a member of the sequence by a relation that includes, for each of the participants, at least one of the values disclosed by the participant.
